(19) United States
(12) Patent Application Publication
(10) Pub. No.: US 2023/0124507 A1
(43) Pub. Date: Apr. 20, 2023

(54) ELECTRO-OPTICAL DEVICE

(71) Applicant: TDK CORPORATION, Tokyo (JP)

(72) Inventors: Kenji NAGASE, Hong Kong (CN); Anthony Reymund Melad BINARAO, Hong Kong (CN); Cheng Bu HENG, Hong Kong (CN); Hiroshi TAKE, Hong Kong (CN)

(73) Assignee: TDK CORPORATION, Tokyo (JP)

(21) Appl. No.: 17/914,610

(22) PCT Filed: Mar. 31, 2021
(86) PCT No.: PCT/JP2021/013933

§ 371 Date: Sep. 26, 2022

(30) Foreign Application Priority Data
Mar. 31, 2020 (CN) 202010243505.6

(51) Int. Cl. G02F 1/225; G02F 1/21; G02F 1/035

(52) U.S. Cl. CPC G02F 1/225; G02F 1/212; G02F 1/035; G02F 2202/20

(57) ABSTRACT

An electro-optical device includes an optical waveguide and an upper electrode provided on the optical waveguide, the optical waveguide is formed by turning back on a plane, the upper electrode has adjacent parts by turning back the optical waveguide, and an upper layer higher than the upper electrode between the adjacent parts includes a metal layer. Alternatively, an electro-optic device includes a plurality of Mach-Zehnder optical waveguides, wherein the Mach-Zehnder optical waveguide includes a first optical waveguide and a second optical waveguide, a first upper electrode is provided on the first optical waveguide and a second upper electrode is provided on the second optical waveguide, and an upper layer higher than the first upper electrode and the second upper electrode between the first upper electrode and the second upper electrode includes a metal layer. An electro-optic device is capable of suppressing electrical crosstalk between components and seeking wide frequency band.

### TECHNICAL FIELD

The present invention relates to an electro-optical device used in the fields of optical communication and optical measurement.

### BACKGROUND ART

Communication traffic has been remarkably increased with widespread Internet use, and optical fiber communication is becoming significantly important. The optical fiber communication is a technology that converts an electric signal into an optical signal and transmits the optical signal through an optical fiber and has wide bandwidth, low loss, and resistance to noise.

As a system for converting an electric signal into an optical signal, there are known a direct modulation system using a semiconductor laser and an external modulation system using an optical modulator. The direct modulation system does not require the optical modulator and is thus low in cost, but has a limitation in terms of high-speed modulation and, thus, the external modulation system is used for high-speed and long-distance applications.

As an optical modulator, an optical modulator using an optical waveguide formed by lithium niobate (LiN_{b}O₃, hereinafter referred to as “LN”) has the advantages of high speed, low loss and less distortion of controlling light waveform. In patent document 1, a Mach-Zehnder type optical modulator with an optical waveguide formed by diffusing Li on the surface of a lithium niobate single crystal (bulk LN) substrate is disclosed.

However, in the optical modulator disclosed in patent document 1, there are two signal electrodes with U-turn, and the signal electrodes are close to each other due to the U-turn. Therefore, electrical crosstalk occurs between components, resulting in an undesirable condition that narrows the frequency band.

### CITATION LIST

### Patent Literature

Prior art Patent Documents

Patent document 1: JP Patent No. 4485218

### SUMMARY OF INVENTION

The present invention is a result of study in view of the above problems, and aims to provide an electro-optical device which may suppress the electrical crosstalk between components and may seek for wide frequency band.

In order to achieve the above object, an aspect of the present invention relates to an electro-optical device, comprising an optical waveguide and an upper electrode provided on the optical waveguide, the optical waveguide is formed by turning back on a plane, the upper electrode has adjacent parts by turning back the optical waveguide, and an upper layer higher than the upper electrode between the adjacent parts comprises a metal layer. In this way, by comprising a metal layer in the upper layer which is higher than the upper electrode between the adjacent parts, electrical crosstalk between adjacent components may be shielded by using the metal layer, thus electrical crosstalk between components may be suppressed and wide frequency band may be sought.

Further, in the electro-optical device according to the above aspect of the present invention, it is preferred that a grounding conductor is provided between the adjacent parts, and the metal layer is connected with the grounding conductor.

Further, in the electro-optical device according to the above aspect of the present invention, it is preferred that the optical waveguide is a Mach-Zehnder optical waveguide having a first optical waveguide and a second optical waveguide which are mutually arranged and turn back on a plane.

Further, in the electro-optical device according to the above aspect of the present invention, it is preferred that an insulating layer is provided between the adjacent parts.

Further, in the electro-optical device according to the above aspect of the present invention, it is preferred that an insulating layer is provided throughout at least a side surface of the upper electrode between the adjacent parts.

Further, in the electro-optical device according to the above aspect of the present invention, it is preferred that an insulating layer is provided throughout at least a side surface and an upper surface of the upper electrode between the adjacent parts.

Further, in the electro-optical device according to the above aspect of the present invention, it is preferred that an insulating layer is filled between the adjacent parts.

Further, in the electro-optical device according to the above aspect of the present invention, the insulating layer is preferably composed of an inorganic substance, more preferably an inorganic oxide. In addition, the insulating layer may be polycrystalline or amorphous.

Another aspect of the present invention relates to an electro-optic device, that is, an electro-optic device having a plurality of Mach-Zehnder optical waveguides, wherein the Mach-Zehnder optical waveguide comprises a first optical waveguide and a second optical waveguide, a first upper electrode is provided on the first optical waveguide and a second upper electrode is provided on the second optical waveguide, and an upper layer higher than the first upper electrode and the second upper electrode between the first upper electrode and the second upper electrode comprises a metal layer. In this way, by comprising a metal layer in the upper layer which is higher than the first upper electrode and the second upper electrode between the first upper electrode and the second upper electrode, electrical crosstalk between adjacent components may be shielded by the use the metal layer, thus electrical crosstalk between components may be suppressed and wide frequency band may be sought.

Further, in the electro-optical device according to the above aspect of the present invention, it is preferred that a grounding conductor is provided between the plurality of Mach-Zehnder optical waveguides, and the metal layer is connected with the grounding conductor.

Further, in the electro-optical device according to the above aspect of the present invention, it is preferred that an insulating layer is provided between the first upper electrode and the second upper electrode.

Further, in the electro-optical device according to the above aspect of the present invention, it is preferred that an insulating layer is provided throughout a side surface of either of the first upper electrode and the second upper electrode between the first upper electrode and the second upper electrode.

Further, in the electro-optical device according to the above aspect of the present invention, it is preferred that an insulating layer is provided throughout a side surface and an upper surface of either of the first upper electrode and the second upper electrode between the first upper electrode and the second upper electrode.

Further, in the electro-optical device according to the above aspect of the present invention, it is preferred that an insulating layer is filled between the first upper electrode and the second upper electrode.

Further, in the electro-optical device according to the above aspect of the present invention, the insulating layer may be preferably composed of inorganic substance, more preferably of inorganic oxide. In addition, the insulating layer may be poly-crystalline or amorphous.

According to one aspect of the present invention, an electro-optic device capable of suppressing electrical crosstalk between components and seeking wide frequency band is provided.

### BRIEF DESCRIPTION OF DRAWINGS

FIG. 1 is a top view of an optical modulator 100 according to a first embodiment of the present invention.

FIG. 2 is a cross-sectional view of the optical modulator along the A-A 'line in FIG. 1.

FIG. 3 is a cross-sectional view of an optical modulator according to a second embodiment of the present invention.

FIG. 4 is a cross-sectional view of an optical modulator according to a first variation of the second embodiment of the present invention.

FIG. 5 is a cross-sectional view of an optical modulator according to a second variation of the second embodiment of the present invention.

FIG. 6 is a cross-sectional view of the optical modulator according to a third variation of the second embodiment of the present invention.

FIG. 7 is a top view of the optical modulator 200 according to a third embodiment of the present invention.

FIG. 8 is a cross-sectional view of the optical modulator along the A-A 'line in FIG. 7.

### DESCRIPTION OF EMBODIMENTS

Preferred embodiments of the present invention will be described in detail with reference to the accompanying drawings. Herein, in the description of the drawings, the same or similar elements are illustrated with the same reference number, and the repeated descriptions are omitted.

### A First Embodiment

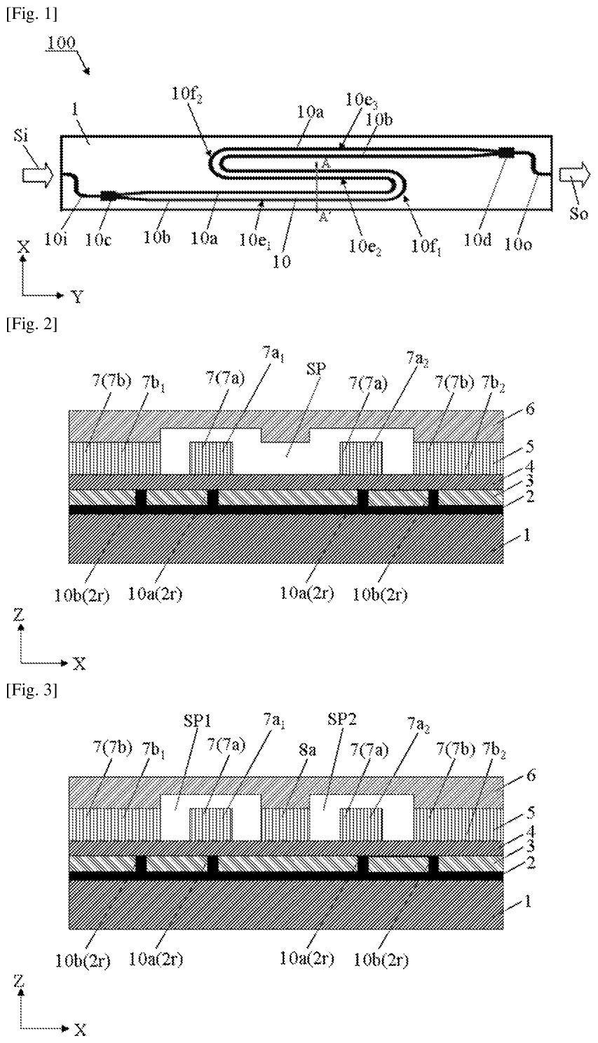

FIG. 1 is a top view of an optical modulator 100 according to a first embodiment of the present invention. FIG. 2 is a cross-sectional view of the optical modulator along the A-A 'line in FIG. 1.

As illustrated in FIGS. 1 and 2, the optical modulator 100 as the electro-optical device according to the present embodiment includes an optical waveguide 10 and an upper electrode 7 provided on the optical waveguide 10.

The optical waveguide 10 is formed by turning back on the plane. For example, in the present embodiment, the optical waveguide 10 is formed by turning back twice on the plane, and thus having first to third linear sections 10e1, 10e2 and 10e3 arranged parallel to one another, a first curved section 10f1 connecting the first and second linear sections 10e1 and 10e2, and a second curved section 10f2 connecting the second and third linear sections 10e2 and 10e3. However, not limited to this, the optical waveguide 10 may be formed by turning back three times or more on the plane.

The optical waveguide 10 is a Mach-Zehnder optical waveguide having a first optical waveguide 10a and a second optical waveguide 10b which are provided in parallel to each other and are formed on a substrate 1.

The first optical waveguide 10a is formed by turning back on the plane, and the second optical waveguide 10b is formed by turning back on the plane. The optical modulator has a problem of a large element length in practical applications. However, by folding the optical waveguide as illustrated in FIG. 1, the element length may be significantly reduced, obtaining a remarkable effect. Particularly, the optical waveguide formed of the lithium niobate film is featured in that it has small loss even when the curvature radius thereof is reduced up to about 50 μcm and is thus suitable for the present embodiment.

The Mach-Zehnder optical waveguide 10 is an optical waveguide having a Mach-Zehnder interferometer structure. The Mach-Zehnder optical waveguide 10 has the first and second optical waveguides 10a and 10b which are branched from a single input optical waveguide 10i at a branch part 10c, and the first and second optical waveguides 10a and 10b are combined into a single output optical waveguide 10o at a multiplexing part 10d. An input light Si is branched at the branch part 10c. The branched lights travel through the first and second optical waveguides 10a and 10b and then multiplexed at the multiplexing part 10d. The multiplexed light is output from the output optical waveguide 10o as a modulated light So. Specifically, the input light Si is input to one end of the first linear section 10e₁, travels from the one end of the first linear section 10e₁ toward the other end thereof, makes a U-turn at the first curved section 10f₁, travels from one end of the second linear section 10e₂ toward the other end thereof in the direction opposite to that in the first linear section 10e₁, makes a U-turn at the second curved section 10f₂, and travels from one end of the third linear section 10e₃ toward the other end thereof in the direction same as that in the first linear section 10e₁.

In addition, the upper electrode 7 comprises a first upper electrode 7a provided on the first optical waveguide 10a and a second upper electrode 7b provided on the second optical waveguide 10b.

In this embodiment, the upper electrode 7 has a first adjacent part 7a₁ and a second adjacent part 7a₂ by turning back the optical waveguide 10, and the second upper electrode 7b has a third adjacent part 7b₁ and a fourth adjacent part 7b₂ indirectly adjacent to each other across the first adjacent part 7a₁ and the second adjacent part 7a₂ by turning back the second optical waveguide 10b. Here, the group composed of the first adjacent part 7a₁ and the third adjacent part 7b₁, and the group composed of the second adjacent part 7a₂ and the fourth adjacent part 7b₂ are referred to as an adjacent part respectively.

As illustrated in FIG. 2, the optical modulator 100 according to the present embodiment has a multilayer structure including a substrate 1, a waveguide layer 2, a protective layer 3, a buffer layer 4, and an electrode layer 5 which are laminated in this order. The substrate 1 is, e.g., a sapphire substrate, and the waveguide layer 2 formed of an electro-optic material, such as a lithium niobate film, is formed on the surface of the substrate 1. The waveguide layer 2 has the first and second optical waveguides 10a and 10b each formed by a ridge part 2r.

The protective layer 3 is formed in an area not overlapping with the first and second optical waveguides 10a and 10b in a plan view. The protective layer 3 covers the entire area of the upper surface of the waveguide layer 2 excluding portions where the ridge parts 2r are formed, and the side surfaces of each of the ridge parts 2r are also covered with the protective layer 3, so that scattering loss caused due to the roughness of the side surfaces of the ridge part 2r may be prevented. The thickness of the protective layer 3 is substantially equal to the height of the ridge part 2r of the waveguide layer 2. There is no particular restriction on the material of the protective layer 3 and, for example, silicon oxide (SiO₂) may be used.

The buffer layer 4 is formed on the upper surfaces of the ridge parts 2r of the waveguide layer 2 so as to prevent light propagating through the first and second optical waveguides 10a and 10b from being absorbed by the first and second upper electrodes 7a and 7b. The buffer layer 4 is preferably formed of a material having a lower refractive index than that of the waveguide layer 2 and a high transparency, and the thickness thereof may be about 0.2 μcm to 1.2 μcm. In the present embodiment, although the buffer layer 4 covers not only the upper surfaces of the respective first and second optical waveguides 10a and 10b, but also the entire underlying surface including the upper surface of the protective layer 3, it may be patterned so as to selectively cover only the vicinity of the upper surfaces of the first and second optical waveguides 10a and 10b. Further, the buffer layer 4 may be directly formed on the upper surface of the waveguide layer 2 with the protective layer 3 omitted.

The film thickness of the buffer layer 4 is preferably as large as possible in order to reduce light absorption of an electrode and preferably as small as possible in order to apply a high electric field to the first and second optical waveguides 10a and 10b. The light absorption and applied voltage of an electrode have a trade-off relation, so that it is necessary to set an adequate film thickness according to the purpose. The dielectric constant of the buffer layer 4 is preferably as high as possible, because the higher the dielectric constant thereof, the more VπL (index representing electric field efficiency) is reduced. Further, the refractive index of the buffer layer 4 is preferably as low as possible, because the lower the refractive index thereof, the thinner the buffer layer 4 may be. In general, a material having a high dielectric constant has a higher refractive index, so that it is important to select a material having a high dielectric constant and a comparatively low refractive index considering the balance therebetween. For example, Al₂O₃ has a specific dielectric constant of about 9 and a refractive index of about 1.6 and is thus preferable. LaAlP₃ has a specific dielectric constant of about 13 and a refractive index of about 1.7, and LaYO₃ has a specific dielectric constant of about 17 and a refractive index of about 1.7 and are thus particularly preferable.

The electrode layer 5 is provided with the first upper electrode 7a and the second upper electrode 7b. The first upper electrode 7a is provided overlapping the ridge part 2r corresponding to the first optical waveguide 10a so as to modulate light traveling inside the first optical waveguide 10a and is opposed to the first optical waveguide 10a through the buffer layer 4. The second upper electrode 7b is provided overlapping the ridge part 2r corresponding to the second optical waveguide 10b so as to modulate light traveling inside the second optical waveguide 10b and is opposed to the second optical waveguide 10b through the buffer layer 4.

In addition, as illustrated in FIG. 2, the upper layer higher than the upper electrode 7 between the adjacent parts comprises a metal layer 6. Specifically, the upper layer higher than the upper electrode 7, between the third adjacent part 7b₁ and the fourth adjacent part 7b₂, comprises a metal layer 6. In this way, by the upper layer higher than the upper electrode between the adjacent parts comprising a metal layer, electrical crosstalk between adjacent components may be shielded by the use of the metal layer, thus the electrical crosstalk between components may be suppressed and the wide frequency band may be sought.

In addition, as illustrated in FIG. 2, a space SP surrounded by the buffer layer 4, the electrode layer 5 and the metal layer 6 may be a cavity or filled with resin or inorganic oxide.

Although the waveguide layer 2 is not particularly limited in type so long as it is formed of an electro-optic material, it is preferably formed of lithium niobate (LiNbO₃). This is because lithium niobate has a large electro-optic constant and is thus suitable as the constituent material of an optical device such as an optical modulator. Hereinafter, the configuration of the present embodiment when the waveguide layer 2 is formed using a lithium niobate film will be described in detail.

Although the substrate 1 is not particularly limited in type as long as it has a lower refractive index than the lithium niobate film, it is preferably a substrate on which the lithium niobate film may be formed as an epitaxial film. Specifically, the substrate 1 is preferably a sapphire single-crystal substrate or a silicon single-crystal substrate. The crystal orientation of the single-crystal substrate is not particularly limited. The lithium niobate film may be easily formed as a c-axis oriented epitaxial film on single-crystal substrates having different crystal orientations. Since the c-axis oriented lithium niobate film has three-fold symmetry, the underlying single-crystal substrate preferably has the same symmetry. Thus, the single-crystal sapphire substrate preferably has a c-plane, and the single-crystal silicon substrate preferably has a (111) surface.

The “epitaxial film” refers to a film having the crystal orientation of the underlying substrate or film. Assuming that the film surface extends in X-Y plane and that the film thickness direction (i.e., the thickness direction of the substrate 1) is Z-axis direction, the crystal of the epitaxial film is uniformly oriented along the X-axis, Y-axis and Z-axis.

The lithium niobate film has a composition of LiₓNbA_{y}O_{z}. A denotes an element other than Li, Nb, and O, wherein x ranges from 0.5 to 1.2, preferably 0.9 to 1.05, y ranges from 0 to 0.5, and z ranges from 1.5 to 4, preferably 2.5 to 3.5. Examples of the element A include K, Na, Rb, Cs, Be, Mg, Ca, Sr, Ba, Ti, Zr, Hf, V, Cr, Mo, W, Fe, Co, Ni, Zn, Sc, and Ce, alone or a combination of two or more of them.

The lithium niobate film preferably has a film thickness of equal to or smaller than 2 μcm. This is because a high-quality lithium niobate film having a thickness larger than 2 μcm is difficult to form. The lithium niobate film having an excessively small thickness cannot completely confine light in it, allowing the light to penetrate through the substrate 1 and/or the buffer layer 4. Application of an electric field to the lithium niobate film may therefore cause a small change in the effective refractive index of the optical waveguides (10a and 10b). Thus, the lithium niobate film preferably has a film thickness that is at least approximately one-tenth of the wavelength of light to be used.

The lithium niobate film is preferably formed using a film formation method, such as sputtering, CVD or sol-gel process. Application of an electric field in parallel to the c-axis of the lithium niobate that is oriented perpendicular to the main surface of the substrate 1 can change the optical refractive index in proportion to the electric field. In the case of the single-crystal substrate made of sapphire, the lithium niobate film may be directly epitaxially grown on the sapphire single-crystal substrate. In the case of the single-crystal substrate made of silicon, the lithium niobate film is epitaxially grown on a clad layer (not illustrated). The clad layer (not illustrated) has a refractive index lower than that of the lithium niobate film and should be suitable for epitaxial growth. For example, a high-quality lithium niobate film may be formed on a clad layer (not illustrated) made of Y₂O₃.

As a formation method for the lithium niobate film, there is known a method of thinly polishing or slicing the lithium niobate single crystal substrate. This method has an advantage that characteristics same as those of the single crystal may be obtained and may be applied to the present invention. A Second Embodiment

FIG. 3 is a cross-sectional view of the optical modulator according to a second embodiment of the present invention. As shown in FIG. 3, the difference between the optical modulator of the present embodiment and the optical modulator 100 of the first embodiment lies in that a grounding conductor 8a is provided between the adjacent parts, that is, between the group composed of the first adjacent part 7a₁ and the third adjacent part 7b₁ and the group composed of the second adjacent part 7a₂ and the fourth adjacent part 7b₂. Specifically, as shown in FIG. 3, a grounding conductor 8a is provided between the first adjacent part 7a₁ and the second adjacent part 7a₂. The other structures of the optical modulator 200 according to the present embodiment are the same as those of the optical modulator 100 according to the first embodiment, so the detailed descriptions are omitted.

Further, in the present embodiment, the metal layer 6 is connected to the grounding conductor 8a. In addition, the spaces SP1 and SP2 respectively surrounded by the buffer layer 4, the electrode layer 5, the metal layer 6 and the grounding conductor 8a may be cavities or filled with resin or inorganic oxide.

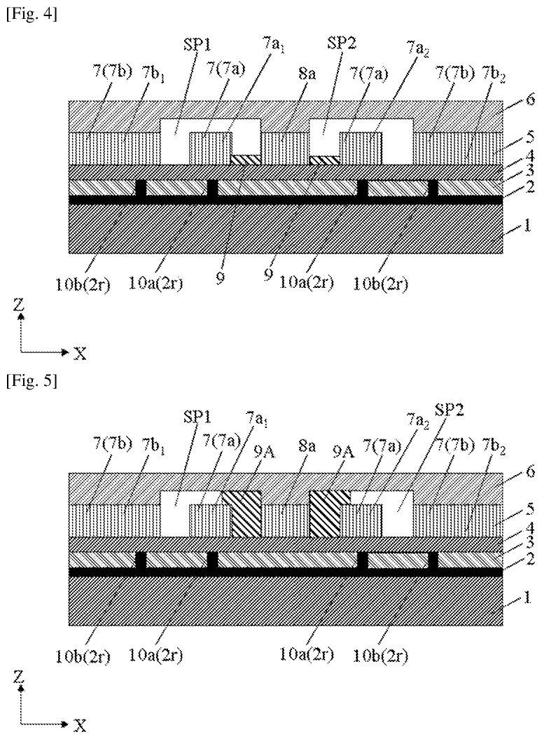

FIG. 4 is a cross-sectional view of an optical modulator according to a first variation of the second embodiment of the present invention. The difference between the optical modulator according to the first variation of the second embodiment and the optical modulator of the second embodiment lies in that insulating layers 9 are provided between the third adjacent part 7b₁ and the fourth adjacent part 7b₂. The other structures of the optical modulator according to the present variation are the same as those of the optical modulator according to the first embodiment, so the detailed descriptions are omitted.

In addition, in the present variation, it is preferred that the insulating layer 9 is formed throughout the side surface of the first upper electrode 7a between the third adjacent part 7b₁ and the fourth adjacent part 7b₂.

FIG. 5 is a cross-sectional view of an optical modulator according to a second variation of the second embodiment of the present invention. The difference between the optical modulator according to the second variation of the second embodiment and the optical modulator of the second embodiment lies in that insulating layers 9A are provided throughout the side surface and upper surface of the first upper electrode 7a between the third adjacent part 7b₁ and the fourth adjacent part 7b₂. The other structures of the optical modulator according to the present variation are the same as those of the optical modulator according to the second embodiment, so the detailed descriptions are omitted.

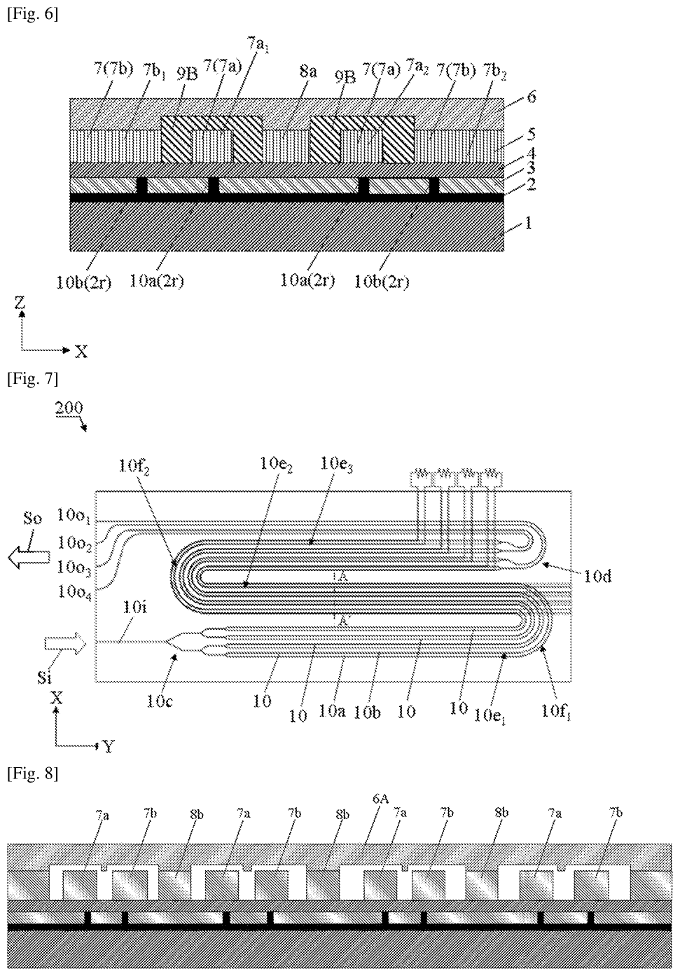

FIG. 6 is a cross-sectional view of an optical modulator according to a third variation of the second embodiment of the present invention. The difference between the optical modulator according to the third variation of the second embodiment and the optical modulator of the second embodiment lies in that the spaces between the third adjacent part 7b₁ and the fourth adjacent part 7b₂ are filled with an insulating layer 9B respectively. The other structures of the optical modulator according to the present variation are the same as those of the optical modulator according to the second embodiment, so the detailed descriptions are omitted.

In addition, in the third variation, it is preferred that the metal layer 6 directly contacts the insulating layer 9B.

In the first to third variations of the second embodiment, as a material of the insulating layer, the insulating layer is preferably composed of an inorganic substance, more preferably an inorganic oxide. In addition, the insulating layer may be polycrystalline or amorphous.

### A Third Embodiment

FIG. 7 is a top view of the optical modulator 200 according to a third embodiment of the present invention. FIG. 8 is a cross-sectional view of the optical modulator along the A-A 'line in FIG. 7.

As shown in FIGS. 7 and 8, the optical modulator 200 according to the present embodiment comprises four optical waveguides 10 and a first upper electrode 7a and a second upper electrode 7b provided on the optical waveguide 10. However, the number of optical waveguides 10 is not particularly limited, and there may be 1-3 or 5 or more optical waveguides 10.

The optical waveguide 10 is a Mach-Zehnder optical waveguide having a first optical waveguide 10a and a second optical waveguide 10b. A plurality of first and second optical waveguides 10a and 10b are branched from a single input optical waveguide 10i at a branch part 10c, and the plurality of first and second optical waveguides 10a and 10b are combined into a plurality of output optical waveguide 100₁, 100₂, 100₃ and 100₄ at a multiplexing part 10d.

A first upper electrode 7a is provided on the first optical waveguide 10a, and a second upper electrode 7b is provided on the second optical waveguide 10b.

A grounding conductor 8b is provided between the respective Mach-Zehnder optical waveguides. The upper layer higher than the first upper electrode 7a and the second upper electrode 7b between the first upper electrode 7a and the second upper electrode 7b comprises a metal layer 6A. In this way, by the first upper electrode and the second upper electrode between the first upper electrode and the second upper electrode comprising a metal layer, electrical crosstalk between adjacent components may be shielded by the use of the metal layer, thus the electrical crosstalk between components may be suppressed and the wide frequency band may be sought.

In addition, in the optical modulator 200 according to the present embodiment, the metal layer 6A is connected with the grounding conductor 8b to form a dual driving mode (that is, a differential driving mode).

Furthermore, the optical modulator 200 according to the present embodiment is preferably provided with an insulating layer in the same way as the first to third variations of the second embodiment, although not shown. Specifically, it may be a structure having an insulating layer between the first upper electrode and the second upper electrode. Alternatively, it may be a structure with an insulating layer provided throughout the side surface of either of the first upper electrode and the second upper electrode between the first upper electrode and the second upper electrode. Alternatively, it may be a structure having an insulating layer provided throughout the side surface and upper surface of either of the first upper electrode and the second upper electrode between the first upper electrode and the second upper electrode. Alternatively, it may be a structure with an insulating layer filled between the first upper electrode and the second upper electrode. In addition, as the insulating layer, the insulating layer may be preferably composed of inorganic substance, more preferably of inorganic oxide, as in the above embodiment. In addition, the insulating layer may be polycrystalline or amorphous.

While the preferred embodiments of the present invention have been described, the present invention is not limited to the above embodiments, and various modifications may be made within the scope of the present invention, and all such modifications are included in the present invention.

For example, in the above embodiments, the optical modulator has the pair of optical waveguides 10a and 10b each formed of the lithium niobate film epitaxially grown on the substrate 1; however, the present invention is not limited to such a structure, but the optical waveguides may be formed of an electro-optic material such as barium titanate or lead zirconium titanate. Further, as the waveguide layer 2, a semiconductor material, a polymer material, or the like having electro-optic effect may be used.

In addition, in the above embodiments, examples of applying the present invention to optical modulators are listed. However, the present invention may also be applied to any electro-optical devices such as optical switches, optical resonators, optical branching circuits, sensor elements, millimeter wave generators, etc.

### REFERENCE SIGNS LIST

1 substrate

2 waveguide layer

3 protective layer

4 buffer layer

5 electrode layer

6 metal layer

6A metal layer

7 upper electrode

7a first upper electrode

7b second upper electrode

7a₁first adjacent part

7a₂ second adjacent part

7b₁third adjacent part

7b₂ fourth adjacent part

8a grounding conductor

8b grounding conductor

9 insulating layers

9A insulating layers

9B insulating layer

10 optical waveguide

10a first optical waveguide

10b second optical waveguide

100 optical modulator

1. An electro-optical device, comprising
an optical waveguide and an upper electrode provided on the optical waveguide, wherein
the optical waveguide is formed by turning back on a plane,
the upper electrode has adjacent parts by turning back the optical waveguide, and
an upper layer higher than the upper electrode between the adjacent parts comprises a metal layer.

2. The electro-optical device as claimed in claim 1, wherein
a grounding conductor is provided between the adjacent parts, and the metal layer is connected with the grounding conductor.

3. The electro-optical device as claimed in claim 1, wherein
the optical waveguide is a Mach-Zehnder optical waveguide having a first optical waveguide and a second optical waveguide which are mutually arranged and turn back on a plane.

4. The electro-optical device as claimed in claim 1, wherein
an insulating layer is provided between the adjacent parts.

5. The electro-optical device as claimed in claim 1, wherein
an insulating layer is provided throughout at least a side surface of the upper electrode between the adjacent parts.

6. The electro-optical device as claimed in claim 1, wherein
an insulating layer is provided throughout at least a side surface and an upper surface of the upper electrode between the adjacent parts.

7. The electro-optical device as claimed in claim 1, wherein
an insulating layer is filled between the adjacent parts.

8. The electro-optical device as claimed in claim 4, wherein
the insulating layer is composed of an inorganic substance.

9. The electro-optical device as claimed in claim 4, wherein
the insulating layer is polycrystalline.

10. The electro-optical device as claimed in claim 4, wherein
the insulating layer is amorphous.

11. An electro-optic device, comprising a plurality of Mach-Zehnder optical waveguides, wherein
the Mach-Zehnder optical waveguide comprises a first optical waveguide and a second optical waveguide,
a first upper electrode is provided on the first optical waveguide, and a second upper electrode is provided on the second optical waveguide, and
an upper layer higher than the first upper electrode and the second upper electrode between the first upper electrode and the second upper electrode comprises a metal layer.

12. The electro-optical device as claimed in claim 11, wherein
a grounding conductor is provided between the plurality of Mach-Zehnder optical waveguides, and the metal layer is connected with the grounding conductor.

13. The electro-optical device as claimed in claim 11, wherein
an insulating layer is provided between the first upper electrode and the second upper electrode.

14. The electro-optical device as claimed in claim 11, wherein
an insulating layer is provided throughout a side surface of either of the first upper electrode and the second upper electrode between the first upper electrode and the second upper electrode.

15. The electro-optical device as claimed in claim 11, wherein
an insulating layer is provided throughout a side surface and an upper surface of either of the first upper electrode and the second upper electrode between the first upper electrode and the second upper electrode.

16. The electro-optical device as claimed in claim 11, wherein
an insulating layer is filled between the first upper electrode and the second upper electrode.

17. The electro-optical device as claimed in claim 13, wherein
the insulating layer is composed of an inorganic substance.

18. The electro-optical device as claimed in claim 13, wherein
the insulating layer is polycrystalline.

19. The electro-optical device as claimed in claim 13, wherein
the insulating layer is amorphous.
